(19) United States
(12) Patent Application Publication
(10) Pub. No.: US 2004/0206000 A1
(43) Pub. Date: Oct. 21, 2004

(54) Security door apparatus

(76) Inventor: Shusaku Yamamoto, Kobe-shi (JP)

Correspondence Address: BIRCH STEWART KOLASCH & BIRCH, PO BOX 747, FALLS CHURCH, VA, 22040-0747, US

(21) Appl. No.: 10/807,586

(22) Filed: Mar. 24, 2004

(30) Foreign Application Priority Data
Apr. 16, 2003 (JP) 2003-111169

(51) Int. Cl. E05F 11/52

(52) U.S. Cl. 49/163

(57) ABSTRACT

The entrance security door apparatus has the object of providing security for the receiver in a condominium, etc., when the receiver must confirm an unexpected visitor, etc., by opening and closing a door such as entrance door. A locking tool is provided so that the door can be opened and closed to the side end side of a door opening frame, wherein the security door apparatus comprises: one side end part of an auxiliary door having a predetermined narrow width is connected to the inner side of the open/close side of the door and the other side end part of the auxiliary door is connected to the inner part of the side end of the open/close side of the door opening frame, and the auxiliary door is linked in such a manner that. When the door is opened, the auxiliary door functions as a barrier in the opening part between the door and the door opening frame. The auxiliary door is formed to have a lattice-shape shape, etc., so that the receiver can visually confirm the outside from the interior.

### FIELD OF THE INVENTION

The present invention relates to a security door apparatus for a condominium, a single-family house, and other entrance doors, etc., in the building field.

### BACKGROUND OF THE INVENTION

Recently, there have been ill-intentioned visitors to condominiums or single-family houses disguised as door-to-door delivery person or a door-to-door sales persons. Once the entrance door is opened, such an unwanted visitor may prove difficult to turn away or may in fact turn out to be an intruder.

To prevent this, a door scope or a TV camera, etc., at the entrance door has been used to confirm the visitor. However, such a device does not allow the receiver to confirm the entire image of the visitor easily and sufficiently. When the visitor is confirmed via the opening part between a door and a door opening frame joined by a door chain, the opening part is very narrow and thus the receiver must open the door completely since he/she cannot receive a delivered package, etc. This has been a cause of difficulty in anticrime measures.

In view of the above, a patent search was carried out with regards to the security of an entrance door. Search results found Japanese Published Unexamined Patent Application No. 9-317347 and Japanese Published Unexamined Patent Application No. 10-227186.

The former publication of Japanese Published Unexamined Patent Application No. 9-317347 suggests a security double door in which an inner door that can be integrally opened with an external door is provided so that a receiver can confirm a visitor while only the inner door is opened. The latter publication of Japanese Published Unexamined Patent Application No. 10-227186 suggests that a door body has at the center part an opening part that has an auxiliary door opened toward the residence interior side through which postal matter or a package is received.

However, both of the publication can be applied to a newly-provided door but are difficult to be applied to an existing door, because these publication require a door to have an opening in which an inner door is provided. These publication do not allow the receiver to safely confirm the entire image of a visitor easily and sufficiently.

### Means for Solving the Problems

The present invention was made in view of the above. In order to solve the above problems, the first object is to provide a security door apparatus for an entrance door, etc., in which a locking tool is provided so that the door can be opened and closed to the side end side of a door opening frame, wherein the security door apparatus comprises: one side end part of an auxiliary door having a predetermined narrow width is connected to the inner side of the open/close side of the door and the other side end part of the auxiliary door is connected to the inner part of the side end of the open/close side of the door opening frame, and the auxiliary door is linked in such a manner that, when the door is opened, the auxiliary door functions as a barrier in the opening part between the door and the door opening frame; and the auxiliary door is linked in such a manner that, when the door is opened, the auxiliary door functions as a barrier in the opening part between the door and the door opening frame; and the auxiliary door is lattice-shaped or louver-shaped so that a receiver can visually confirm the outside from interior.

By the structure as described above, even in a situation where the receiver has to open the door to greet an unexpected door-to-door delivery person or door-to-door sales person, etc., the lattice-shape auxiliary door is positioned as a barrier between the door and the door opening frame so that the receiver can sufficiently confirm the outside through between the lattice of the auxiliary door. In this way, the receiver can ensure a secure environment in which the receiver can judge the visitor in a composed manner without being caught off guard. The receiver also can correctly listen to the voice of the visitor through the opened door. The entrance security door apparatus of the present invention also can be easily applied to an existing door if needed.

Another object of the present invention is to provide a security door apparatus wherein both side end parts of the auxiliary door are rotatably connected to one side end part of the door and one side end part of the door opening frame, respectively, and one side end part of the auxiliary door is slidably provided at one side end part of the door or one side end part of the door opening frame so that one side end part of the auxiliary door can be opened and closed in accordance with the opening and closing of the door. Thus, the auxiliary door can be positioned as a barrier between the door and the door opening frame.

Still another object of the present invention is to provide a security door apparatus wherein one side end part of the auxiliary door is attachably and detachably provided at one side end part of the door or at one side end part of the door opening frame. When the auxiliary door is not required, an engagement/disengagement lever can be operated to lock the auxiliary door to the door side so that the door can be opened and closed conventionally.

Still another object of the present invention is to provide a security door apparatus wherein one side end part of the auxiliary door of aluminum or iron having a narrow width has axial support parts at the upper and lower parts, whereby these axial support parts are attachably and detachably attached to locking bearing parts that are provided at the upper and lower end parts of the door opening frame or the inner surface of the door, and the axial support parts are formed at the upper and lower parts of the other side end part of the auxiliary door, and these axial support parts provided at the upper and lower parts of the door or the inner surface of the door opening frame are slidably attached to slide guides having a predetermined length.

This allows one side end part of the auxiliary door to be pivotally supported at the upper and lower parts of the door opening frame or the door and allows the other side end part to slide along the slide guides provided at the upper and lower parts of the inner surface of the door or the door opening frame side, thus allowing the auxiliary door to be opened and closed in accordance with the opening and closing of the door.

The present invention also provides a security door apparatus wherein a notch part is provided at the contacting part of the door lock knob of the auxiliary door in order to prevent the auxiliary door from making contact with the door lock knob so that the auxiliary door can be opened and closed without causing the door lock knob to make contact with the auxiliary door.

Furthermore, the present invention provides a security door apparatus wherein the auxiliary door is formed to be foldable so that both side end parts of this auxiliary door are rotatably connected to one side end parts of the door and the door opening frame, respectively and/or at least the upper half part of the auxiliary door has a lattice-shape or louver-shape structure through which a receiver can confirm the outside. Thus, the slide guide is eliminated to provide the auxiliary door with a simplified structure and, the auxiliary door is positioned as a barrier between the door and the door opening frame, and through between the lattice of the auxiliary door, the receiver can sufficiently confirm the outside.

Still furthermore, the present invention provides a security door apparatus wherein one side end part of the auxiliary door is attachably and detachably provided at one side end part of the door or at one side end part of the door opening frame, a width of the auxiliary door is formed slightly larger than the width of a delivered package for a door-to-door delivery, etc., and this auxiliary door partially is provided with openably and closably an opening and closing window through which the package is received. When the auxiliary door is not required, then the engagement/disengagement lever can be operated to lock the auxiliary door at the door side so that the door can be opened and closed conventionally. A width of the auxiliary door is formed slightly larger than the width of a delivered package for door-to-door delivery, etc., and this auxiliary door partially is provided with an opening and closing window through which the package is received. This allows, even when the auxiliary door is positioned as a barrier between the door and the door opening frame, the receiver to receive a delivered package by the opening and closing window provided in the auxiliary door, thus providing increased security.

Still furthermore, the present invention also provides a security door apparatus wherein the auxiliary door is provided with the locking tool for locking the locking tool of the door or the locking tool is surrounded by a cover in order to prevent the locking tool of the door from being subjected to lock-picking or the locking tool of the door has at the inner side of the locking part a locking tool for sandwiching the thumbturn part of the locking part to provide a locked status that is slidably or rotatably provided at the auxiliary door. Thus, the door locking tool can be prevented from being subjected to lock-picking via the auxiliary door and the thumbturn of the locking tool can be prevented from being rotated, thus providing increased security.

Further scope or applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a perspective view (a) illustrating one embodiment of the entrance security door apparatus of the present invention and an inner view (b),

FIG. 2 is a cross-sectional view illustrating the opening/closing mechanism of the same above,

FIG. 3 is a diagram illustrating the engagement/disengagement of an axially supported part of the auxiliary door,

FIGS. 4 (a), (b) illustrate how the locking device of the door prevents lock-picking of the same above,

FIGS. 5 (a), (b) are cross-sectional views illustrating another embodiment of the same above,

FIG. 6 is an inner view (a) illustrating still another embodiment of the same above, and cross-sectional views (b) and (c) illustrate how the entrance security door apparatus is opened or closed,

FIGS. 7 (a), (b) are cross-sectional views illustrating still another embodiment of the same above, and

FIG. 8 is a cross-sectional view illustrating still another embodiment of the same above.

### DETAILED DESCRIPTION OF THE INVENTION

A security door apparatus of this invention is characterized by providing a locking tool so that the door can be opened and closed to the side end side of a door opening frame, wherein the security door apparatus comprises: one side end part of an auxiliary door having a predetermined narrow width is connected to the inner side of the open/close side of the door and the other side end part of the auxiliary door is connected to the inner part of the side end of the open/close side of the door opening frame, and the auxiliary door is linked in such a manner that, when the door is opened, the auxiliary door functions as a barrier in the opening part between the door and the door opening frame; and the auxiliary door has a lattice-shape or louver-shape so that a receiver can visually confirm the outside from the interior.

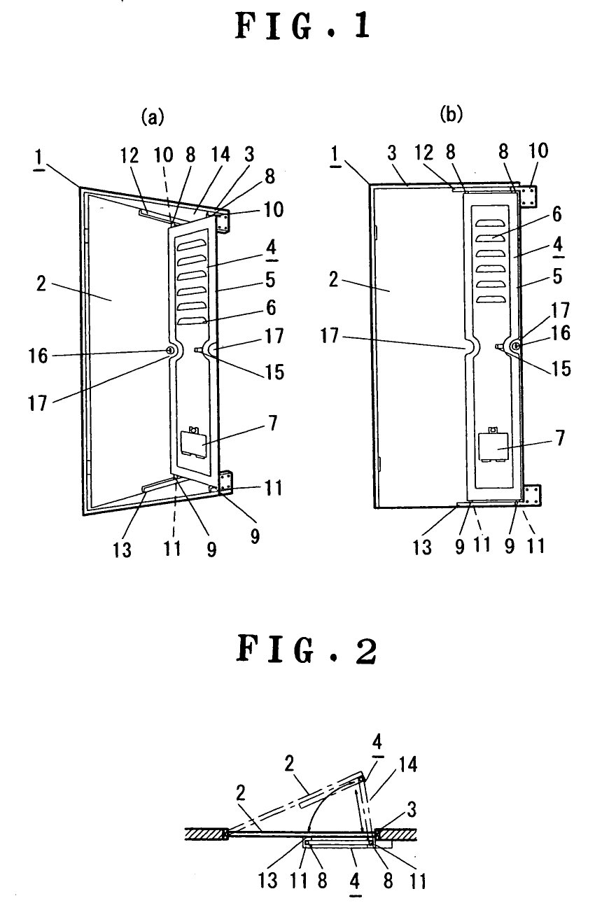

As shown in FIGS. 1(a) and (b), the security door apparatus of the present invention of the door 2 for an entrance and the door opening frame 3 are connected to the auxiliary door 4, and when a visitor opens the door 2, the auxiliary door 4 separates an exterior and an interior so that security is provided.

As shown in FIGS. 1(a) and (b), it is preferable that the structure of the above auxiliary door 4 comprises, a predetermined small width that is slightly wider than the width of a delivered package for a door-to-door delivery, etc., wherein the rigid frame body 5 is provided with the lattice or louver 6, etc., at least at the upper half part, and so a receiver can confirm the outside from the interior such as lattice door to ensure security. It is also especially preferable that the opening and closing window 7 for a delivered package wherein a door-to-door delivery, etc., can be received provided at least at the lower half part of the rigid frame body 5 is openably and closably provided from the indoor side.

As shown in FIG. 1 and FIG. 2, this auxiliary door 4 is provided with, at the upper and lower parts of both side ends, the axial support parts 8 and 9 in a projected manner, respectively. Locking bearing parts 10 and 11 are provided at the upper and lower parts of the inner side part of the side end of the open/close side of the door 2 and at the upper and lower parts of the inner side of the side end part of the open/close side of the door opening frame 3, respectively. The locking bearing parts 10 and 11 are engaged with the axial support parts 8 and 9 so that the auxiliary door 4 is connected.

As shown in FIG. 1 and FIG. 2, the upper and lower parts of the door 2 is provided with the slide guides 12 and 13 having a predetermined length to which the locking bearing parts 10 and 11 at the above-described door 2 side are slidably attached. As shown in FIG. 1(a), this allows the auxiliary door 4 to be positioned to separate the opening part 14 between the door 2 and the door opening frame 3 in accordance with the opening and closing of the door 2. As a result, the interior and the exterior can be securely separated by the auxiliary door 4 even when the door 2 is opened, thus providing security.

The locking bearing parts 10 and 11 preferably have a cylindrical shape so that the locking bearing parts 10 and 11 are rotatably engaged with the slide guides 12 and 13. However, this may be optional. The slide guides 12 and 13 also have a position stopper for limiting or adjusting the opening and closing of the auxiliary door 4 so that the opening and closing of the auxiliary door 4 can be adjusted.

The axial support parts 8 and 9 at one side end side of the above auxiliary door 4 are linked as shown in FIG. 3 so as to be connected to the engagement/disengagement lever 15. As a result, the axial support parts 8 and 9 can be engaged with or disengaged from the locking bearing parts 10 and 11 of the door opening frame 3 by operating the engagement/disengagement lever 15. When the axial support parts 8 and 9 are disengaged from the locking bearing parts 10 and 11, the door 2 can be conventionally opened or closed from/toward the door opening frame 3. When the axial support parts 8 and 9 are disengaged from the locking bearing parts 10 and 11, the auxiliary door 4 is preferably locked to the door 2 via an appropriate locking part (not shown), etc. Here, a contact part of the auxiliary door 4 provided with a locking knob 16 of the door 2 may have an appropriate means such the notch part 17 provided as shown in FIG. 1 and FIG. 2.

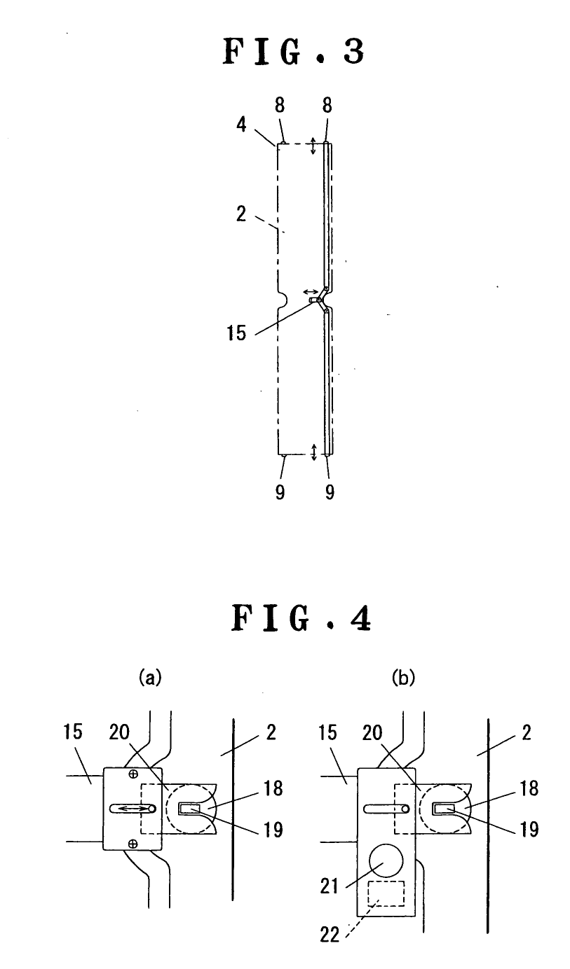

As shown in FIG. 4(a), the auxiliary door 4 also has a locking tool 20 that provides a locked state by sandwiching the locking part 19 slidably and rotatably provided at the locking part 19 of the interior for the locking tool 18 of the door 2. This provides a further security means for preventing the locking tool 18 of the door 2 from being subjected to lock-picking. When the locking part 19 cannot be sandwiched, then an effective and appropriate means may be provided, such as a means for covering or surrounding the locking part 19.

As shown in FIG. 4(b), the locking tool 20 also may have an auto-lock part 21, such as a motor, so that the locking tool 20 can be locked or unlocked by remotely controlling the controller 22 from the outside of the door 2.

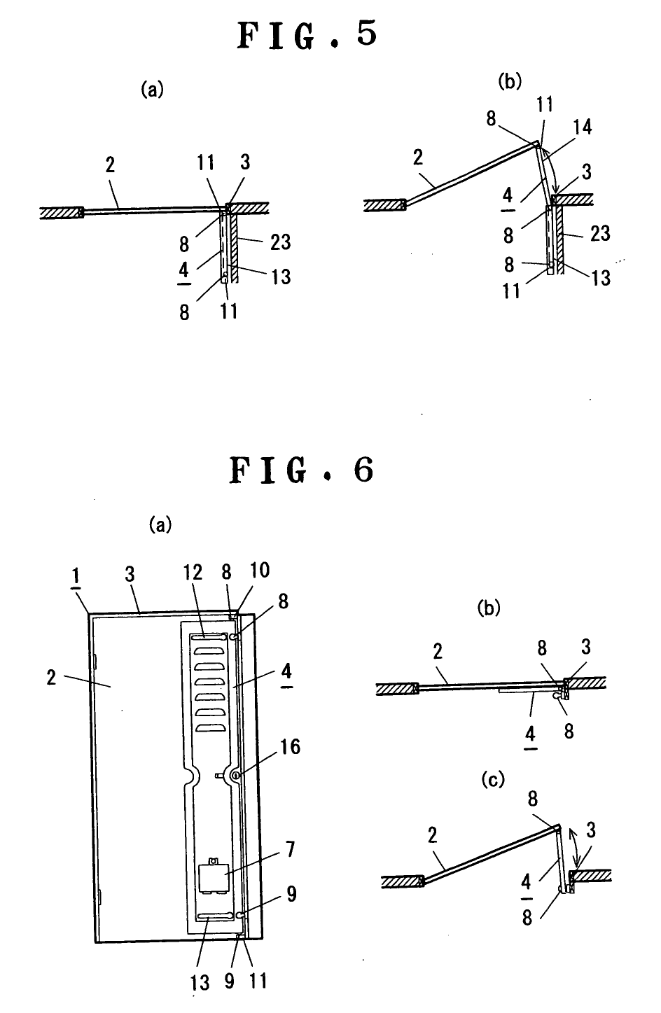

As shown in FIGS. 5(a) and (b), for the above-described auxiliary door 4, the slide guides 12 and 13 for sliding are provided at the side wall 23 side of the door opening frame 3 side. As shown in FIGS. 5(a) and 5(b), the auxiliary door 4 can be slidably provided at the door side or at the door opening frame side.

As shown in FIGS. 6(a) and (b), the above-described auxiliary door 4 has the slide guides 12 and 13 at the upper and lower parts and the door opening frame 3 side has the axial support parts 8 and 9 that are provided to be engageable with or disengageable from the slide guides 12 and 13. As shown in FIG. 6(c), the slide guides 12 and 13 of the auxiliary door 4 are engaged with the axial support parts 8 and 9 at the door opening frame 3 side so that the auxiliary door 4 can function as a barrier.

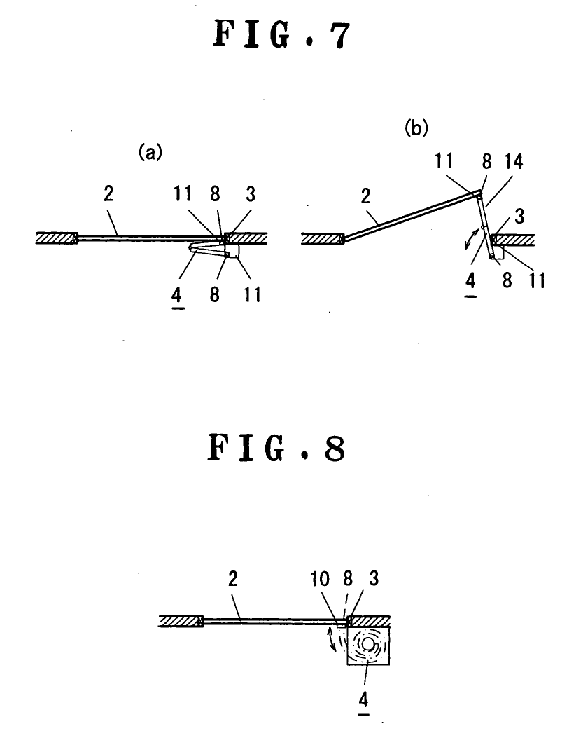

Further, as shown in FIGS. 7(a) and (b), the auxiliary door 4 is formed to be foldable so that both side end parts of this auxiliary door 4 are attached to the side end part of the open/close side of the door 2 as described above and the locking bearing parts 10 and 11 at the upper and lower parts of the inner side part of the door opening frame 3 (so that one side end part can be attached and detached).

Furthermore, as shown in FIG. 8, the auxiliary door 4 is a flexible structure such as a roll shutter in which at the door opening frame 3 the roll shutter-like auxiliary door 4 is wound in the inner side part of the longitudinal direction so that the free end part of this auxiliary door 4 is attachably and detachably connected to the side end part of the open/close side of the door 2 by the means, etc., described above.

As described above, the entrance security door apparatus of the present invention may be applied to other embodiments in accordance with the object of the present invention. Such embodiments include one in which the auxiliary door has a lattice that is expandable and retractable in parallel. The entrance security door apparatus of the present invention also may be applied to other doors other than an entrance door for a condominium and a single-family house.

### Embodiments

FIG. 1 to FIG. 4 illustrate one embodiment of the entrance door of the present invention for a condominium, etc. The auxiliary door 4 is made of aluminum or iron with a width of 400 mm. The surrounding frame body 5 has the integrally-provided louver 6 at the upper half part and the opening and closing window 7 having a size of 300×280 mm at the lower half part is provided openably and closably from the inner side. The auxiliary door 4 has the inner rod-shaped axial support parts 8 and 9 provided to have a length that is almost half of the height of the auxiliary door 4 at both side end parts. As shown in FIG. 3, the inner side end of the axial support parts 8 and 9 is protruded to the engagement/disengagement lever 15 so that the auxiliary door 4 can be linked in a retractable manner.

The axial support parts 8 and 9 at both upper and lower side ends of this auxiliary door 4 are engaged with: the plate-shaped slide guides 12 and 13 that are provided at the upper and lower parts of the inner side surface of the door 2 and that have an overturned U-shaped cross part; and the locking bearing parts 10 and 11 at the inner side of the open/close side of the door opening frame 3, respectively. As a result, in accordance with the opening and closing of the door 2, the auxiliary door 4 is positioned to work as a barrier between the door 2 and the door opening frame 3. The auxiliary door 4 has a circular arc-shaped notch part 17 at the center so that the auxiliary door 4 can be smoothly opened and closed without making contact with the knob 16 of the door 2.

As shown in FIGS. 4(a) and (b), the auxiliary door 4 also has the locking tool 20 that sandwiches the locking part 19 of the door 2 to lock the locking part 19 and that is provided in a slidable manner. This prevents the locking part 19 of the door 2 from being subjected to lock-picking.

The construction as described above allows, even when an unexpected door-to-door delivery person or door-to-door sales person visits a receiver and the receiver has to unlock the door 2 to open the door 2, the auxiliary door 4 to be positioned as a barrier between the door 2 and the door opening frame 3 as shown in FIG. 1(a) so that the receiver can sufficiently confirm the outside through the louver 6 of the auxiliary door 4 while having conversing with the visitor. In this way, the receiver can ensure a secure environment in which the receiver can judge the visitor in a composed manner without being caught off guard.

When the auxiliary door 4 is not required, then the engagement/disengagement lever 15 can be operated to retract the axial support parts 8 and 9 so that the axial support parts 8 and 9 can be unlocked from the locking bearing parts 10 and 11. As a result, the door 2 can be opened and closed conventionally by locking the auxiliary door 4 to the locking part at the door 1 side.

Furthermore, the locking tool 20 of the auxiliary door 4 can be used to lock the locking part 19 of the door 2 to prevent lock-picking, thus providing further security.

FIGS. 5(a) and (b) illustrate another embodiment of the present invention in which the slide guides 12 and 13 of the auxiliary door 4 of the above embodiment are provided at the inner side wall 23 of the door opening frame 3. This also provides security, etc., above-described.

FIGS. 6(a) to (c) show still another embodiment of the present invention. In this embodiment, auxiliary door 4 has the slide guides 12 and 13 at the upper and lower parts and has the axial support parts 8 and 9 that are attached to the slide guides 12 and 13 in an engageable or disengageable manner at the door opening frame 3 side. As shown in this embodiment, the auxiliary door 4 also may be attached with the slide guides 12 and 13 so that the axial support parts 8 and 9 may be engaged with the slide guides 12 and 13.

FIGS. 7(a) and (b) show still another embodiment of the present invention. In this embodiment, the auxiliary door 4 is formed to be foldable, and the upper and lower parts of axial support parts 8 and 9 of both side end parts thereof are attached to the side end part of the open/close side of the door 2, and the locking bearing parts 10 and 11 provided at the upper and lower parts of the inner side part of the door opening frame 3. This embodiment eliminates the slide guide and can provide an auxiliary door having a simple structure.

FIG. 8 shows still another embodiment of the present invention in which the auxiliary door 4 has a flexible structure like a roll shutter. The auxiliary door 4 in this embodiment is provided by jointing strips so that the auxiliary door 4 is wound in the door opening frame 3 in the longitudinal direction to allow the free end part of this auxiliary door 4 to be attachably and detachably connected to the side end part of the open/close side of the door 2. As described above, the auxiliary door can have an appropriate shape in accordance with the customer, including a sheet-like shape, a foldable-shape, a roll shape, and a shape that is linked to be expandable and retractable in parallel. In this way, the auxiliary door can have an appropriate and fashionable design in accordance with the door.

1. A security door apparatus for an entrance door, etc., in which a locking tool is provided so that the door can be opened and closed to the side end side of a door opening frame, wherein the security door apparatus comprises:
one side end part of an auxiliary door having a predetermined narrow width is connected to the inner side of the open/close side of the door and the other side end part of the auxiliary door is connected to the inner part of the side end of the open/close side of the door opening frame, and the auxiliary door is linked in such a manner that, when the door is opened, the auxiliary door functions as a barrier in the opening part between the door and the door opening frame; and
the auxiliary door has a lattice-shape or louver-shape so that a receiver can visually confirm the outside from the interior.

2. A security door apparatus according to claim 1, wherein both side end parts of the auxiliary door are rotatably connected to one side end part of the door and one side end part of the door opening frame, respectively, and one side end part of the auxiliary door is slidably provided at one side end part of the door or one side end part of the door opening frame so that one side end part of the auxiliary door can be opened and closed in accordance with the opening and closing of the door.

3. A security door apparatus according to claim 2, wherein one side end part of the auxiliary door is attachably and detachably provided at one side end part of the door or at one side end part of the door opening frame.

4. A security door apparatus according to claim 3, wherein one side end part of the auxiliary door of aluminum or iron having a narrow width has axial support parts at the upper and lower parts, whereby these axial support parts are attachably and detachably attached to locking bearing parts that are provided at the upper and lower end parts of the door opening frame or the inner surface of the door, and the axial support parts are formed at the upper and lower parts of the other side end part of the auxiliary door, and these axial support parts provided at the upper and lower parts of the door or the inner surface of the door opening frame are slidably attached to slide guides having a predetermined length.

5. A security door apparatus according to claim 3, wherein a notch part is provided at the contacting part of the door lock knob of the auxiliary door in order to prevent the auxiliary door from making contact with the door lock knob.

6. A security door apparatus according to claim 3, claim 3 or 4, wherein at least the upper half part of the auxiliary door has a lattice-shape or louver-shape structure through which a receiver can confirm the outside.

7. A security door apparatus according to claim 3, claim 3 or 4, wherein the auxiliary door is formed to be foldable so that both side end parts of this auxiliary door are rotatably connected to one side end parts of the door and the door opening frame, respectively.

8. A security door apparatus according to claim 4, wherein one side end part of the auxiliary door is attachably and detachably provided at one side end part of the door or at one side end part of the door opening frame, a width of the auxiliary door is formed slightly larger than the width of a delivered package for a door-to-door delivery, etc., and this auxiliary door partially is provided with openably and closably an opening and closing window through which the package is received.

9. A security door apparatus according to claim 8, wherein the auxiliary door is provided with the locking tool for locking the locking tool of the door or the locking tool is surrounded by a cover in order to prevent the locking tool of the door from being subjected to lock-picking.

10. A security door apparatus according to claim 9, wherein the locking tool of the door has at the inner side of the locking part a locking tool for sandwiching the thumbturn part of the locking part to provide a locked status that is slidably or rotatably provided at the auxiliary door.
